(19) United States
(12) Patent Application Publication
(10) Pub. No.: US 2026/0064027 A1
(43) Pub. Date: Mar. 5, 2026

(54) PRINT HEAD AND IMAGE FORMING APPARATUS

(71) Applicant: SHARP KABUSHIKI KAISHA, Sakai City (JP)

(72) Inventors: Akito TERAMOTO, Sakai City (JP); Katsuaki YAMADA, Sakai City (JP); Songhuan PIAO, Sakai City (JP); KENZO OHKUBO, Sakai City (JP); ATSUSHI UEDA, Sakai City (JP)

(21) Appl. No.: 19/305,133

(22) Filed: Aug. 20, 2025

(30) Foreign Application Priority Data
Aug. 30, 2024 (JP) 2024-149984

(51) Int. Cl. G03G 15/04; G03G 15/043

(52) U.S. Cl. CPC G03G 15/04054; G03G 15/0435; G03G 2215/0409

(57) ABSTRACT

A print head 3 includes: a substrate (311) having a plurality of light-emitting elements 31; an elongated lens array 32, and an elongated lens holder 313. The lens array 32 and the lens holder 313 are bonded to each other in a plurality of bonding regions H(1) to H(n) arranged in a longitudinal direction L within a facing area α where the lens array 32 and the lens holder 313 face each other. The plurality of bonding regions H(1) to H(n) include first bonding regions H(2), . . . , and H(n-1) located on one side in an optical axis direction N of the plurality of light-emitting elements 31 and second bonding regions H(1), H(3), . . . , and H(n) located on an opposite side in the optical axis direction N.

### CROSS-REFERENCE TO RELATED APPLICATIONS

The present application claims priority from Japanese Application JP 2024-149984, the content to which is hereby incorporated by reference into this application.

### BACKGROUND OF THE INVENTION

### 1. Field of the Invention The present disclosure relates to a print head and an image forming apparatus such as a photocopier, a multifunctional machine, a printer, and a facsimile machine.

### 2. Description of the Related Art

In general, a print head includes a substrate (light-emitting element substrate) having a plurality of light-emitting elements arranged in a line, an elongated lens array that focuses light emitted by the plurality of light-emitting elements onto an image carrier (for example, a photoreceptor drum), and an elongated lens holder that holds the lens array.

### SUMMARY OF THE INVENTION

In some cases, the lens array and the lens holder are bonded to each other using an adhesive in a plurality of bonding regions arranged in the longitudinal direction within a facing area where the lens array and the lens holder face each other (region where the lens holder holds the lens array). In regions within the facing area other than the bonding regions, the lens array and the lens holder are in direct contact (close contact) with each other, and the adhesive is not applied. In such a configuration, in a case where the plurality of bonding regions are located only on one of the two sides of the facing area in the optical axis direction of the plurality of light-emitting elements (one side in the optical axis direction) (for example, concentrated toward one end in the optical axis direction), the adhesive may shrink as the adhesive cures, causing the lens array to warp (curve) into a bow shape. If warping occurs in the lens array as described above, the distance between the lens array and each individual light-emitting element becomes inconsistent across different image heights, resulting in focus misalignment at positions offset from the reference plane of the lens array.

In this regard, in general print heads in which a lens array and a lens holder (support member) are bonded to each other using an adhesive in a plurality of bonding regions arranged in the longitudinal direction, no measures are taken against warping of the lens array due to adhesive shrinkage.

It is therefore an object of the present disclosure to provide a print head and an image forming apparatus that make it possible to reduce warping of a lens array due to adhesive shrinkage.

In order to solve the problems described above, a print head according to an aspect of the present disclosure includes: a substrate having a plurality of light-emitting elements arranged in a line; an elongated lens array that focuses light emitted by the plurality of light-emitting elements onto an image carrier; and an elongated lens holder that holds the lens array, wherein the lens array and the lens holder are bonded to each other in a plurality of bonding regions arranged in a longitudinal direction within a facing area where the lens array and the lens holder face each other, and the plurality of bonding regions include first bonding regions located on one side in an optical axis direction of the plurality of light-emitting elements and second bonding regions located on an opposite side in the optical axis direction.

An image forming apparatus according to another aspect of the present disclosure includes the print head according the foregoing aspect of the present disclosure.

According to the present disclosure, it is possible to reduce warping of a lens array due to adhesive shrinkage.

### BRIEF DESCRIPTION OF THE DRAWINGS

FIG. 1 is a cross-sectional view of an image forming apparatus according to an embodiment of the present disclosure.

FIG. 2 is a perspective view of an example of print heads provided on main body frames in the image forming apparatus according to the embodiment of the present disclosure, as viewed from diagonally above the front side.

FIG. 3 is a perspective view of one of the print heads shown in FIG. 2 supported on a bridging part, as viewed from diagonally above the front side.

FIG. 4 is a perspective view of the print head, as viewed from diagonally above the back side.

FIG. 5 is a perspective view of the print head shown in FIG. 4, as viewed from diagonally below the front side.

FIG. 6 is an exploded perspective view of the print head shown in FIG. 4, as viewed from diagonally above the front side.

FIG. 7 is an exploded perspective view of the print head shown in FIG. 4, as viewed from diagonally below the back side.

FIG. 8 is a cross-sectional perspective view of the print head, as viewed from diagonally above the front side.

FIG. 9 is a cross-sectional view of the print head.

FIG. 10 is a schematic diagram showing the cross-sectional view shown in FIG. 9 with enhanced clarity.

FIG. 11 is a plan view of a light-emitting element panel, a flexible circuit board, and a printed wiring board that form the print head, with the flexible circuit board extending in a straight line.

FIG. 12 is a perspective view for explaining an example of a first step of a method for manufacturing the print head.

FIG. 13 is a perspective view for explaining an example of a second step of the method for manufacturing the print head.

FIG. 14 is a perspective view for explaining an example of a third step of the method for manufacturing the print head.

FIG. 15 is a perspective view for explaining an example of a fourth step of the method for manufacturing the print head.

FIG. 16 is a perspective view for explaining an example of a fifth step of the method for manufacturing the print head.

FIG. 17 is a perspective view for explaining an example of a sixth step of the method for manufacturing the print head.

FIG. 18 is a diagram including vertical cross-sectional views of the embodiment of the present disclosure taken along a longitudinal direction, illustrating an example of a portion of a lens holder before an adhesive is applied (upper illustration) and the portion of the lens holder after the adhesive has been applied (lower illustration).

FIG. 19 is an enlarged plan view of a portion of the print head including the lens holder shown in FIG. 18.

FIG. 20 is an explanatory diagram for explaining warping in a first warping direction in each of first bonding regions.

FIG. 21 is an explanatory diagram for explaining warping in a second warping direction in each of second bonding regions.

FIG. 22 is a diagram including vertical cross-sectional views taken along the longitudinal direction, illustrating the lens holder before the adhesive is applied to the first bonding regions (upper illustration) and after the adhesive has been applied (lower illustration).

FIG. 23 is a diagram including vertical cross-sectional views taken along the longitudinal direction, illustrating the lens holder before the adhesive is applied to the second bonding regions (upper illustration) and after the adhesive has been applied (lower illustration).

FIG. 24 is a vertical cross-sectional view taken along a width direction, illustrating the lens holder after the adhesive has been applied to the first bonding regions.

FIG. 25 is a vertical cross-sectional view taken along the width direction, illustrating the lens holder after the adhesive has been applied to the second bonding regions.

FIG. 26 is a vertical cross-sectional view of the embodiment of the present disclosure taken along the longitudinal direction, illustrating another example of the portion of the lens holder after the adhesive has been applied.

FIG. 27 is a vertical cross-sectional view of the embodiment of the present disclosure taken along the longitudinal direction, illustrating another example of the portion of the lens holder after the adhesive has been applied.

FIG. 28 is a diagram including vertical cross-sectional views of a reference example taken along the longitudinal direction, illustrating an example of a portion of a lens holder before an adhesive is applied (upper illustration) and the portion of the lens holder after the adhesive has been applied (lower illustration).

### DETAILED DESCRIPTION OF THE INVENTION

The following describes embodiments of the present disclosure with reference to the accompanying drawings. In the following description, the same components are denoted by the same reference signs. The same components have the same names and the same functions. As such, detailed description thereof will not be repeated.

### Image Forming Apparatus

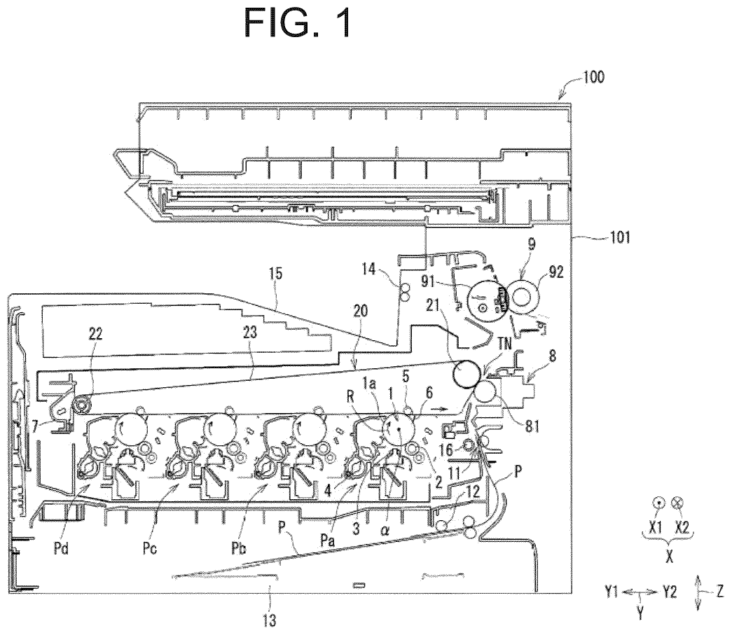

FIG. 1 is a cross-sectional view of an image forming apparatus 100 according to an embodiment of the present disclosure. It should be noted that the following description is based on the drawings in which X represents a rotation axis direction of a photoreceptor drum 1, X1 represents a front side, X2 represents a back side, Y represents a left-right direction perpendicular to the rotation axis direction X, Y1 represents a right side, Y2 represents a left side, and Z represents an up-down direction perpendicular to the rotation axis direction X and the left-right direction Y.

Image data that is handled in an image forming apparatus main body 101 of the image forming apparatus 100 corresponds to a color image that is formed using black (K), cyan (C), magenta (M), and yellow (Y) colors or a monochrome image that is formed using a single color (for example, black). In order to form four different toner images corresponding to the respective colors, therefore, four photoreceptor drums 1 (image carriers), four chargers 2, four print heads 3, four developing devices 4, four primary transfer devices 5, and four drum cleaners 6 are provided, constituting four image stations Pa, Pb, Pc, and Pd respectively corresponding to black, cyan, magenta, and yellow. It should be noted that the image forming apparatus 100 may be a monochrome image forming apparatus.

In each of the image stations Pa, Pb, Pc, and Pd, the corresponding charger 2 uniformly charges, to a predetermined potential, a surface 1a of the corresponding photoreceptor drum 1 being driven to rotate in a predetermined rotation direction R. Each of the print heads 3 exposes the surface 1a of the corresponding photoreceptor drum 1 to light to form an electrostatic latent image on the surface 1a of the photoreceptor drum 1. Each of the developing devices 4 develops the electrostatic latent image on the surface 1a of the corresponding photoreceptor drum 1 to form a toner image on the surface 1a of the photoreceptor drum 1. As a result, the toner images of the respective colors are formed on the surfaces 1a of the respective photoreceptor drums 1. Each of the drum cleaners 6 removes and collects residual toner from the surface 1a of the corresponding photoreceptor drum 1. The primary transfer devices 5 sequentially transfer and superimpose the toner images of the respective colors from the surfaces 1a of the photoreceptor drums 1 onto an intermediate transfer belt 23 in rotational movement caused by a drive roller 21 and a driven roller 22 in a belt drive device 20, so that a color toner image is formed on the intermediate transfer belt 23. A belt cleaner 7 removes and collects residual toner from the intermediate transfer belt 23.

A transfer nip TN is formed between the intermediate transfer belt 23 and a transfer roller 81 of a secondary transfer device 8. The transfer roller 81 of the secondary transfer device 8 receives, in the transfer nip TN, a sheet P such as recording paper transported through a sheet transport path 11 and transfers the color toner image from the surface of the intermediate transfer belt 23 onto the sheet P while transporting the sheet P together with the intermediate transfer belt 23. A fixing device 9 receives the sheet P between a fixing member (fixing belt 91 in this example) and a pressure member (pressure roller 92 in this example), and applies heat and pressure thereto to fix the color toner image on the sheet P.

The sheet P is taken out from a paper feed cassette 13 by a pickup roller 12, is transported through the sheet transport path 11, passes through the secondary transfer device 8 and the fixing device 9, and is discharged onto a paper discharge tray 15 using discharge rollers 14. Rollers such as a registration roller 16 are disposed along the sheet transport path 11. The registration roller 16 temporarily stops the sheet P, aligns the leading edge of the sheet P, and then starts transporting the sheet P in synchronization with the timing of the toner image transfer at the transfer nip TN between the intermediate transfer belt 23 and the transfer roller 81.

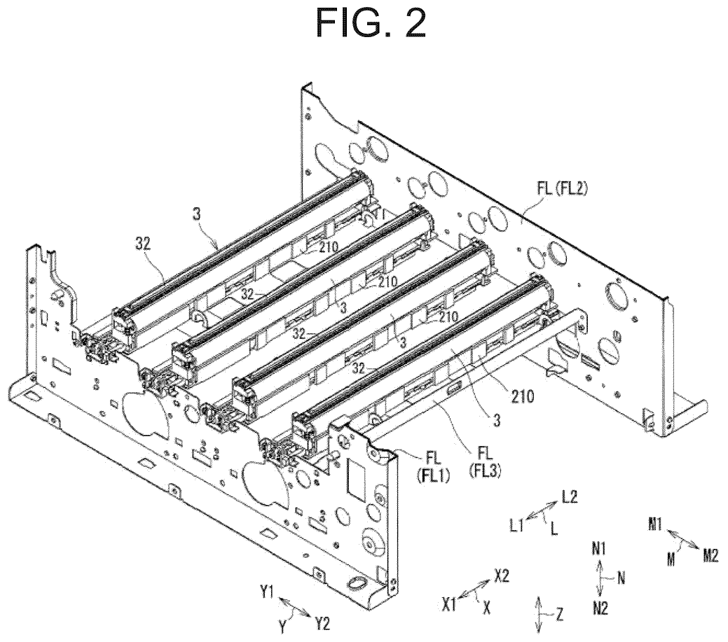

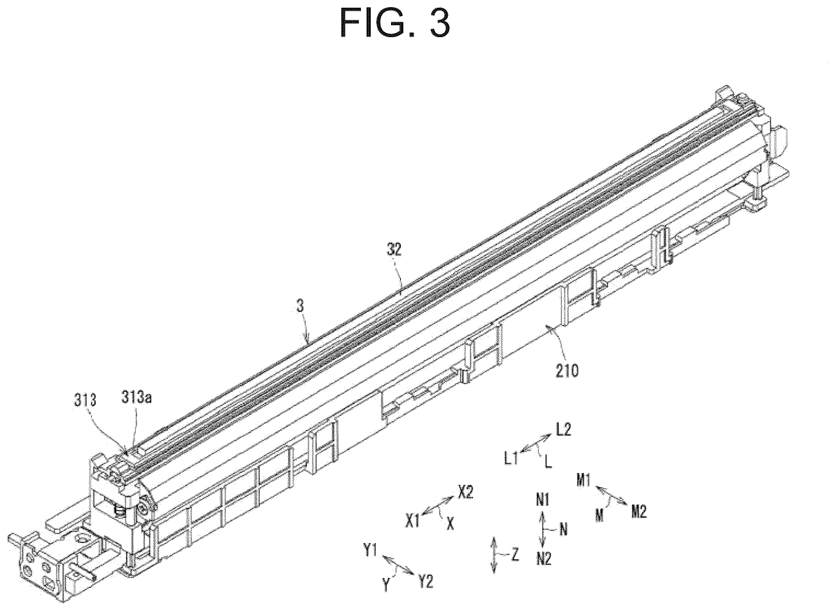

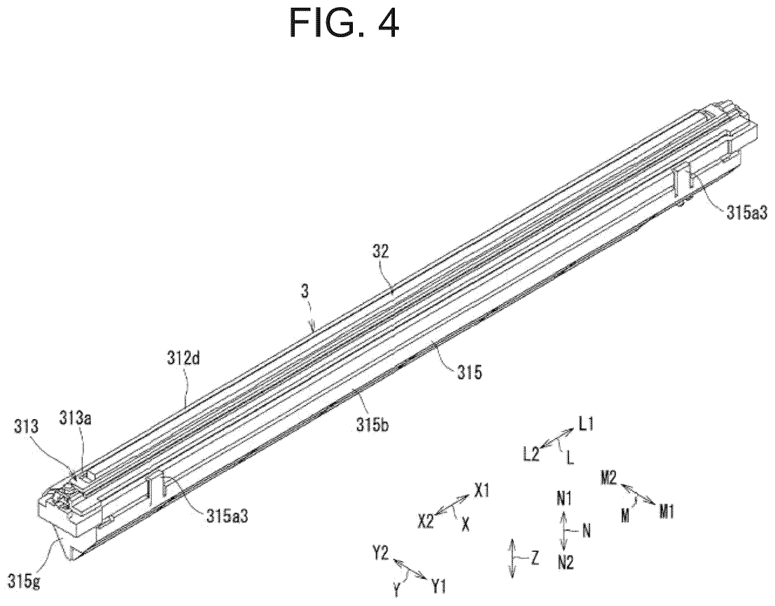

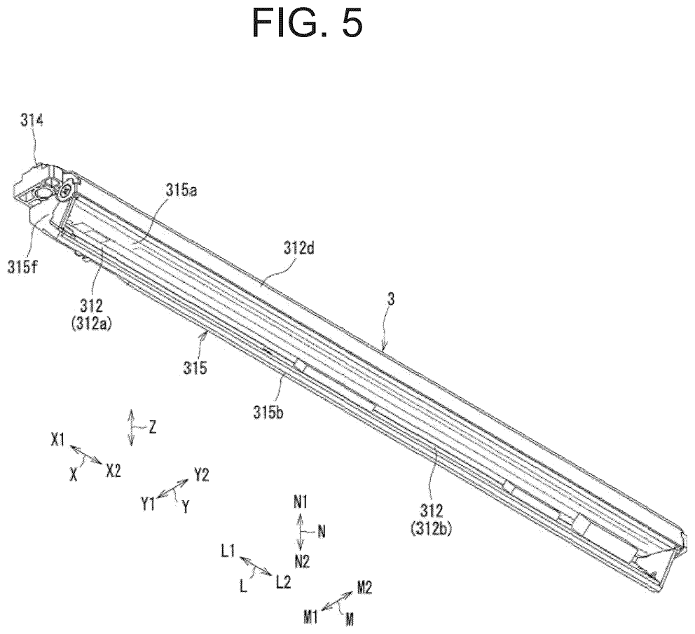

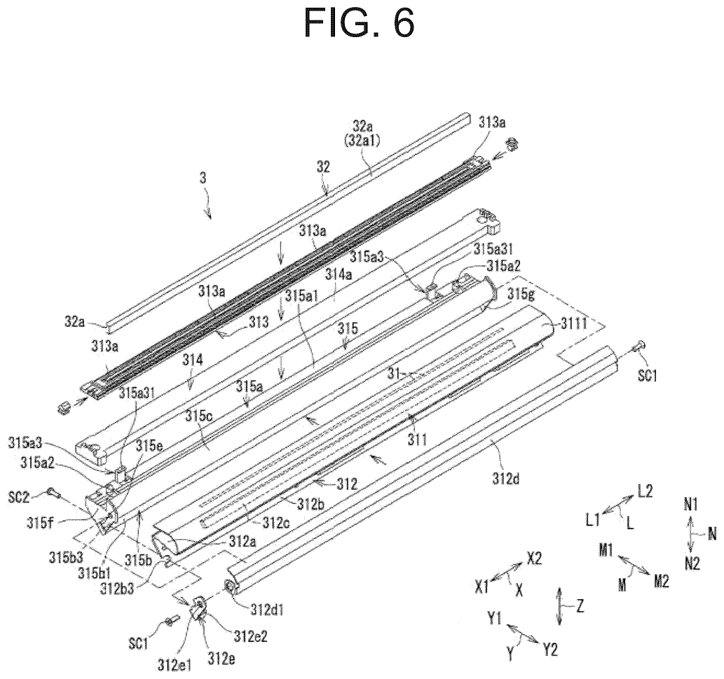

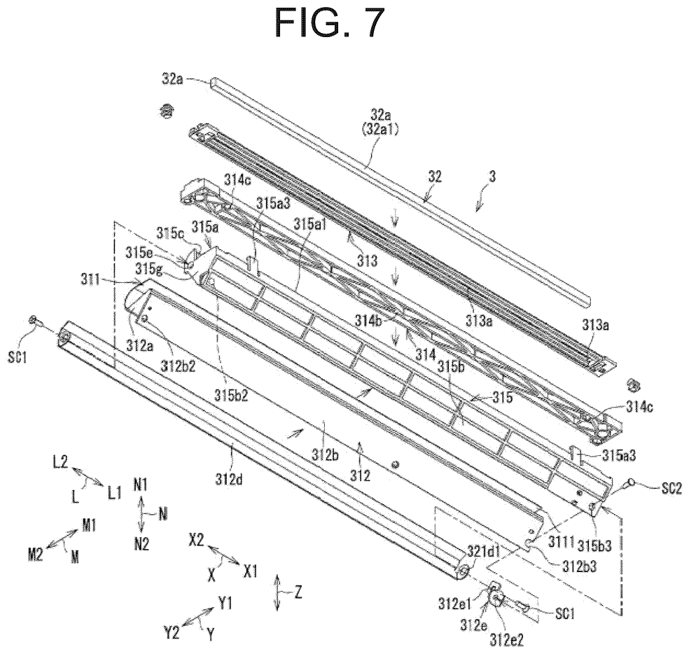

FIG. 2 is a perspective view of an example of the print heads 3 provided on main body frames FL (FL1 to FL3) in the image forming apparatus 100 according to the embodiment of the present disclosure, as viewed from diagonally above the front side X1. FIG. 3 is a perspective view of one of the print heads 3 shown in FIG. 2 supported on a bridging part 210, as viewed from diagonally above the front side X1. FIG. 4 is a perspective view of the print head 3, as viewed from diagonally above the back side X2. FIG. 5 is a perspective view of the print head 3 shown in FIG. 4, as viewed from diagonally below the front side X1. FIG. 6 is an exploded perspective view of the print head 3 shown in FIG. 4, as viewed from diagonally above the front side X1, and FIG. 7 is an exploded perspective view of the print head 3 shown in FIG. 4, as viewed from diagonally below the back side X2.

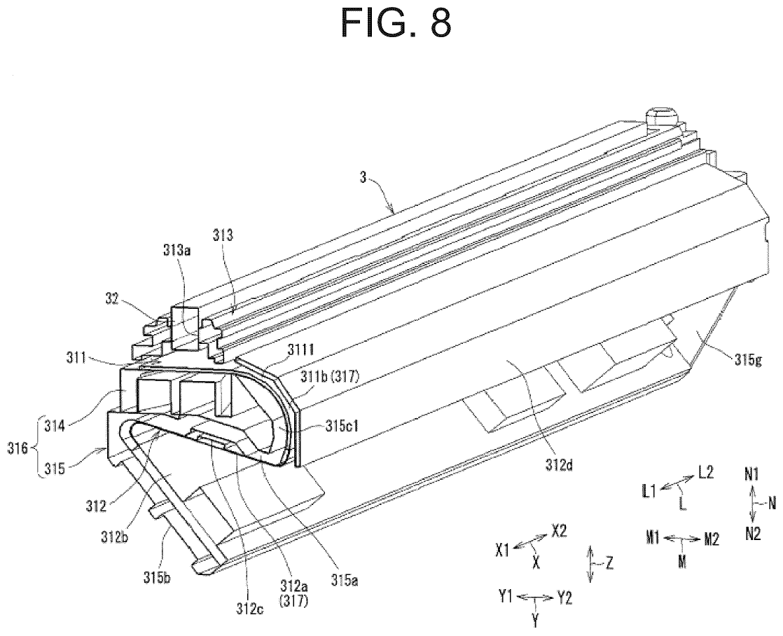

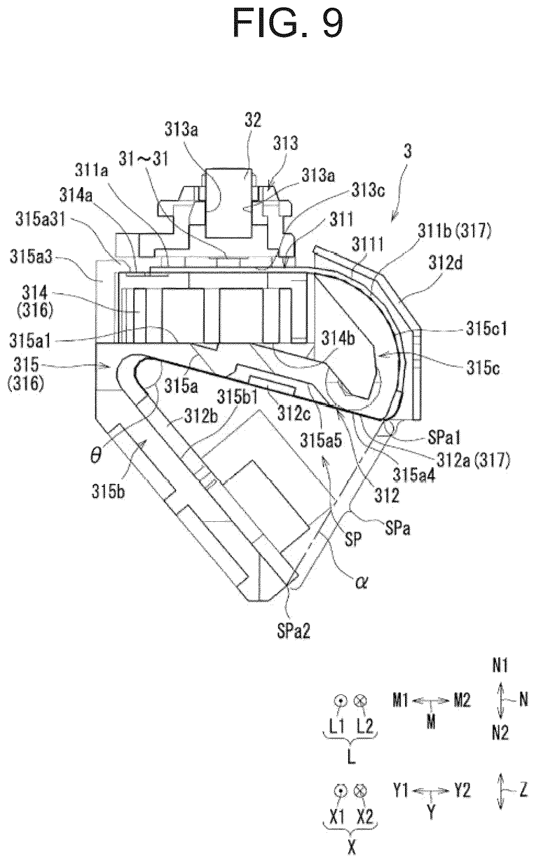

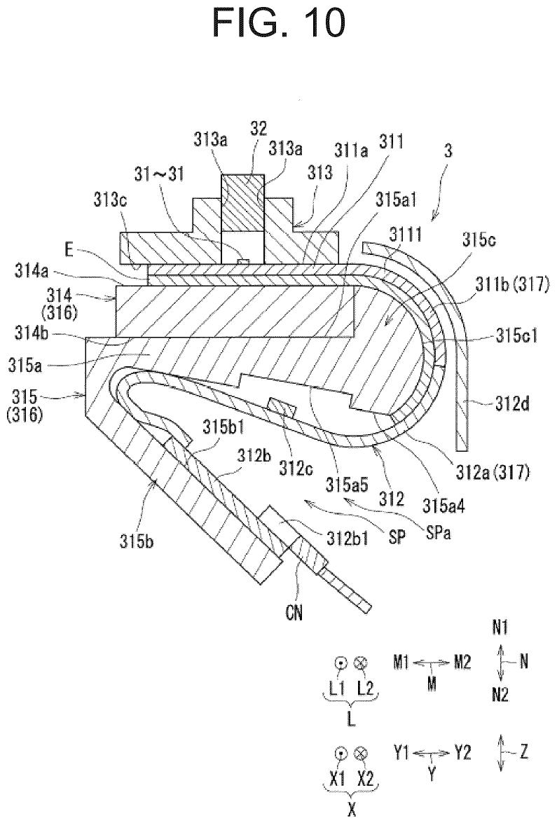

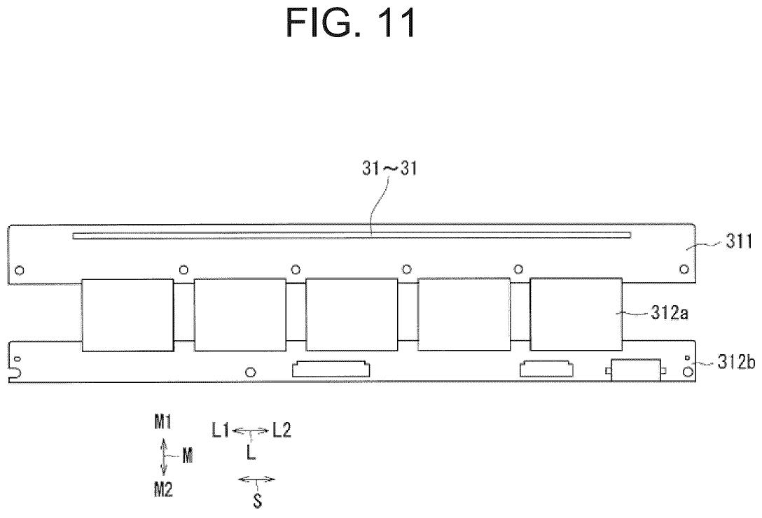

FIG. 8 is a cross-sectional perspective view of the print head 3, as viewed from diagonally above the front side. FIG. 9 is a cross-sectional view of the print head 3. FIG. 10 is a schematic diagram showing the cross-sectional view shown in FIG. 9 with enhanced clarity. FIG. 11 is a plan view of a light-emitting element panel 311 (light-emitting element substrate), a flexible circuit board 312a, and a printed wiring board 312b that form the print head 3, with the flexible circuit board 312a extending in a straight line.

Hereinafter, the embodiment of the present disclosure is described on the assumption that a plurality of light-emitting elements 31 in each print head 3 are organic light-emitting diodes (OLED), each of which is referred to below simply as OLED. It should be noted that the light-emitting elements 31 are not limited to OLEDs, and may be other types of light-emitting elements such as inorganic light-emitting diodes (LEDs) or, for example, Nano light-emitting diodes (nanoscale light-emitting diodes), which are submicrometer light-emitting diodes (LEDs).

The print heads 3 all have the same configuration. As such, one print head 3 is shown in each of FIGS. 3 to 11. The print heads 3 are, for example, referred to simply as a print head 3 in the following description. The same applies to other components that may be provided corresponding to the different colors.

The image forming apparatus 100 according to the embodiment of the present disclosure includes a photoreceptor drum 1 and an elongated print head 3. The print head 3 includes the light-emitting element panel 311 and a lens array 32. The light-emitting element panel 311 has a plurality of light-emitting elements 31 (see FIGS. 9 to 11). The light-emitting elements 31 emit light to expose the surface 1a of the photoreceptor drum 1 to the light.

The light-emitting elements 31 are arranged in a line in a longitudinal direction L of the print head 3. In this example, the light-emitting element panel 311 is a film-shaped panel (flexible OLED panel) (light-emitting element panel) with the OLED elements (31) mounted thereon. This configuration makes it possible to achieve reductions in size and costs of the print head 3.

The lens array 32 extends in the longitudinal direction L and focuses light emitted by the light-emitting elements 31 onto the surface 1a of the photoreceptor drum 1. The lens array 32 is positioned opposite the light-emitting elements 31.

The print head 3 is provided on the bridging part 210. The bridging part 210 bridges the main body frames FL of the image forming apparatus main body 101 (see FIG. 1) (in this example, spans between the main body frame FL1 on the front side X1 and the main body frame FL2 on the back side X2).

In this example, the main body frame FL3 spans between the main body frames FL1 and FL2 along the rotation axis direction X and the left-right direction Y. The bridging part 210 is disposed on the main body frame FL3.

### Print Head

The print head 3 further includes a drive member 312, a lens holder 313, a fixing member 314 (base member), and a main body member 315 as shown in FIGS. 8 to 11. The fixing member 314 and the main body member 315 form a support member 316. The drive member 312 drives the light-emitting elements 31. The lens holder 313 holds the lens array 32. The fixing member 314 fixes the lens holder 313 with the light-emitting element panel 311 fixed. The main body member 315 holds the drive member 312, the lens holder 313, and the fixing member 314.

In this example, the drive member 312 has the flexible circuit board 312a (connection cable member), the printed wiring board 312b (PWB) (connection board), a drive circuit element 312c, and a protective member 312d. One end of the connection cable member (312a) is connected to one end of the light-emitting element panel 311, and an opposite end thereof is connected to one end of the printed wiring board 312b. The connection cable member (312a) is a flexible circuit board (COF: Chip on Film) including a film on which the drive circuit element 312c (driver IC) for driving the OLED elements (31) on the light-emitting element panel 311 is mounted. The printed wiring board 312b connected to the connection cable member (312a) has an input terminal 312b1 (see FIG. 10) (connector terminal) and is connected to a connector CN (see FIG. 10) via the input terminal 312b1.

The protective member 312d protects exposed portions of the light-emitting element panel 311 and the connection cable member (312a). The connector CN is connected to an image processing device (not shown) provided in the image forming apparatus main body 101. It should be noted that in FIG. 10, the light-emitting elements 31 are shown protruding from an outer surface of the light-emitting element panel 311 for illustrative purposes. However, as shown in FIG. 9, the light-emitting elements 31 are actually provided (for example, vapor-deposited) inside the light-emitting element panel 311 without protruding from the outer surface of the light-emitting element panel 311.

The lens holder 313 is a frame-shaped member for surrounding outer surfaces 32a (see FIGS. 6 and 7) of the lens array 32 that are in parallel with an optical axis direction N of the light-emitting elements 31. Note here that the optical axis direction N refers to a direction (thickness direction) perpendicular to both the longitudinal direction L and a width direction M of the print head 3. The width direction M refers to a direction perpendicular to an arrangement direction S in which the plurality of light-emitting elements 31 are arranged in a line. The lens array 32 is inserted into an inner peripheral surface 313a of the lens holder 313, which serves as a frame-shaped member. At least one of the outer surfaces 32a of the lens array 32 (in this example, side surfaces 32a1 extending in the longitudinal direction L) are held by the lens holder 313 and is bonded using an adhesive (for example, ultraviolet curing adhesive) at least at one location (at a plurality of locations in this example). An area around the bonded area between the lens array 32 and the lens holder 313 is sealed using a sealant (sealing resin). This configuration effectively prevents dust and other foreign matter from entering the lens holder 313 through the bonded area between the lens array 32 and the lens holder 313.

The fixing member 314 has a rectangular parallelepiped shape. A surface of the light-emitting element panel 311 having the light-emitting elements 31 on a side opposite to a light-emitting elements 31 side is bonded to an upper surface 314a of the fixing member 314 on the photoreceptor drum 1 side (one side N1) in the optical axis direction N (see FIG. 10) using an adhesive member E (for example, double-sided adhesive tape). A lower surface 313c of the lens holder 313 is fixed to a panel surface 311a of the light-emitting element panel 311 facing away from the fixing member 314. An area around the bonded area between the lens holder 313 and the light-emitting element panel 311 is sealed using a sealant (sealing resin). This configuration effectively prevents dust and other foreign matter from entering the lens holder 313 through the bonded area between the lens holder 313 and the light-emitting element panel 311.

Relative positions between the plurality of light-emitting elements 31 and the lens array 32 (positions in the longitudinal direction L, the width direction M, and the optical axis direction N) are adjusted and set in advance using a jig or the like in a manufacturing process.

The main body member 315 has a placement section 315a, a bent section 315b, and a panel guiding section 315c. The placement section 315a, the bent section 315b, and the panel guiding section 315c are integrally formed.

The fixing member 314 is placed on the placement section 315a. The placement section 315a has a placement surface 315a1 on which the fixing member 314 is placed in such a manner that a lower surface 314b of the fixing member 314 on the bridging part 210 side is in contact with the placement surface 315a1. This configuration allows the fixing member 314 to be reliably placed on the placement surface 315a1 of the placement section 315a. The placement surface 315a1 of the placement section 315a has a plurality of (two) positioning protrusions or recesses (positioning protrusions 315a2 in this example) (see FIG. 6). The lower surface 314b of the fixing member 314 has positioning recesses or protrusions (positioning recesses 314c in this example) corresponding to the plurality of (two) positioning protrusions or recesses (315a2) (see FIG. 7). This configuration allows the fixing member 314 to be reliably positioned with respect to the main body member 315. The placement section 315a has a plurality of (two) holding portions 315a3 (see FIGS. 6, 7 and 9). The placement section 315a and the holding portions 315a3 are integrally formed. The holding portions 315a3 hold the fixing member 314 attached to the placement section 315a in a detachable manner. The holding portions 315a3 restrict the fixing member 314 from moving toward the light-emitting elements 31 (toward the one side N1) in the optical axis direction N. The holding portions 315a3 have engagement portions 315a31 (see FIG. 9) that engage with the upper surface 314a of the fixing member 314.

The bent section 315b is bent at an acute angle (for example, 60 degrees or less; approximately 50 degrees in this example) to the placement section 315a. The printed wiring board 312b is fixed to a facing surface 315b1 (inner surface) of the bent section 315b facing toward the placement section 315a. The input terminal 312b1 is provided at an end of the printed wiring board 312b on an entrance side (opening SPa side) of a space SP between the placement section 315a and the bent section 315b, and the connector CN is connected to the input terminal 312b1 in a direction toward the space SP.

The panel guiding section 315c has a curved portion 315c1 that folds, toward the space SP, a film-shaped protruding portion 317 protruding from the support member 316 (314, 315). The curved portion 315c1 is curved so that a lens holder 313 side of the protruding portion 317 (in this example, a side extending between the light-emitting element panel 311 and the connection cable member (312a)) is folded at 180 degrees or more. The curved portion 315c1 protrudes from the lens holder 313 toward one side M1 or an opposite side M2 in the width direction M (toward the opposite side M2 in this example). In the curved portion 315c1, a panel portion 311b of the light-emitting element panel 311 on the connection cable member (312a) side and a portion of the connection cable member (312a) on the light-emitting element panel 311 side are bonded to each other using the adhesive member E. This configuration allows the curved portion 315c1 to reliably fold the protruding portion 317 (connection cable member (312a) in this example) into the space SP. The protective member 312d is positioned opposite a portion of the protruding portion 317 corresponding to the curved portion 315c1 and is curved along the curved portion 315c1. As shown in FIGS. 6 and 7, the protective member 312d is fastened to a mating fastening portion 315e (female screw) of the main body member 315 with a fastening member SC1 (male screw) inserted in a through hole 312e1 of a retainer 312e and a through hole 312d1 of the protective member 312d at one side L1 in the longitudinal direction L. This configuration allows an end of the protective member 312d on the one side L1 in the longitudinal direction L to be fixed to the main body member 315.

Likewise, the protective member 312d is fastened to a mating fastening portion 315e of the main body member 315 with a fastening member SC1 inserted in a through hole 312d1 of the protective member 312d at an opposite side L2 in the longitudinal direction L. This configuration allows an end of the protective member 312d on the opposite side L2 in the longitudinal direction L to be fixed to the main body member 315. The printed wiring board 312b is positioned with a positioning hole 312b2 of the printed wiring board 312b mating with a positioning protrusion 315b2 of the bent section 315b at the opposite side L2 in the longitudinal direction L. In this state, the printed wiring board 312b is fastened to a mating fastening portion 312e2 (female screw) of the retainer 312e with a fastening member SC2 (male screw) inserted in a through hole 315b3 of the bent section 315b and a through recess 312b3 of the printed wiring board 312b at the one side L1 in the longitudinal direction L. This configuration allows the protective member 312d to be held in position relative to the bent section 315b.

An end of a portion (the connection cable member (312a)) of the protruding portion 317 on the printed wiring board 312b side in the space SP is folded at an edge between the placement section 315a and the bent section 315b, and is connected to the printed wiring board 312b.

The drive circuit element 312c is provided on a placement section 315a side of the connection cable member (312a). A facing surface 315a4 (inner surface) of the placement section 315a facing toward the bent section 315b has a recess 315a5 for preventing interference with the drive circuit element 312c on the connection cable member (312a).

The main body member 315 has a pair of side plates 315f and 315g (see FIGS. 6 and 7) that close two ends of the space SP in the longitudinal direction L.

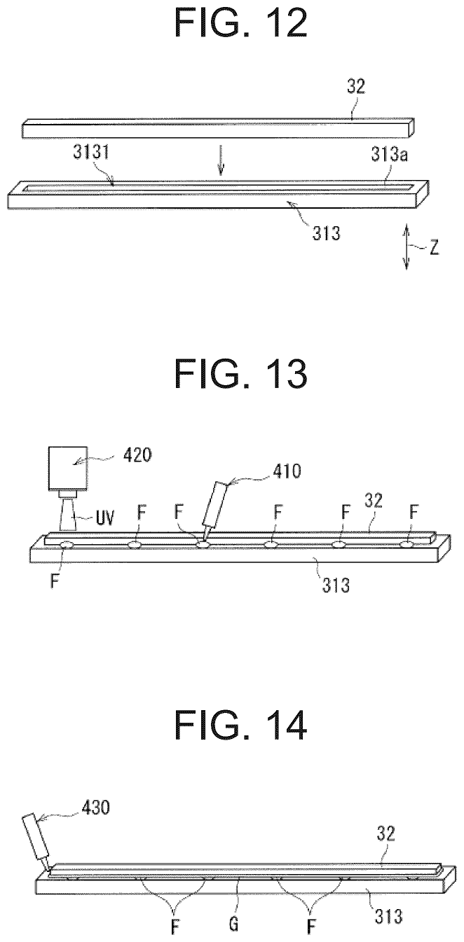

The following now describes a method for manufacturing the print head 3 with reference to FIGS. 12 to 17.

FIGS. 12 to 17 are perspective views for respectively illustrating examples of first to sixth steps of the method for manufacturing the print head 3. It should be noted that FIGS. 12 to 17 show steps for disposing the lens array 32 in the lens holder 313, disposing the light-emitting element panel 311 on the fixing member 314, and disposing the lens holder 313 on the light-emitting element panel 311.

First, in the method for manufacturing the print head 3, the lens array 32 is inserted into the inner peripheral surface (313a) of the lens holder 313 (in this example, an elongated through hole 3131 oriented in the up-down direction Z) as shown in FIG. 12 (first step).

Next, as shown in FIG. 13, a dispenser 410 is used to uniformly apply an ultraviolet curing adhesive F to a plurality of locations in a peripheral area between the lens array 32 and the lens holder 313. Subsequently, an ultraviolet irradiation device 420 is used to irradiate the ultraviolet curing adhesive F with ultraviolet light UV, causing the ultraviolet curing adhesive F to cure (second step). Thus, the lens array 32 can be reliably held by the lens holder 313.

Next, as shown in FIG. 14, a sealant application device 430 is used to apply a sealant G (sealing resin) to the peripheral area between the lens array 32 and the lens holder 313 to seal a gap between the lens array 32 and the lens holder 313 (third step). Thus, dust and other foreign matter can be prevented from entering the lens holder 313 through the gap between the lens array 32 and the lens holder 313.

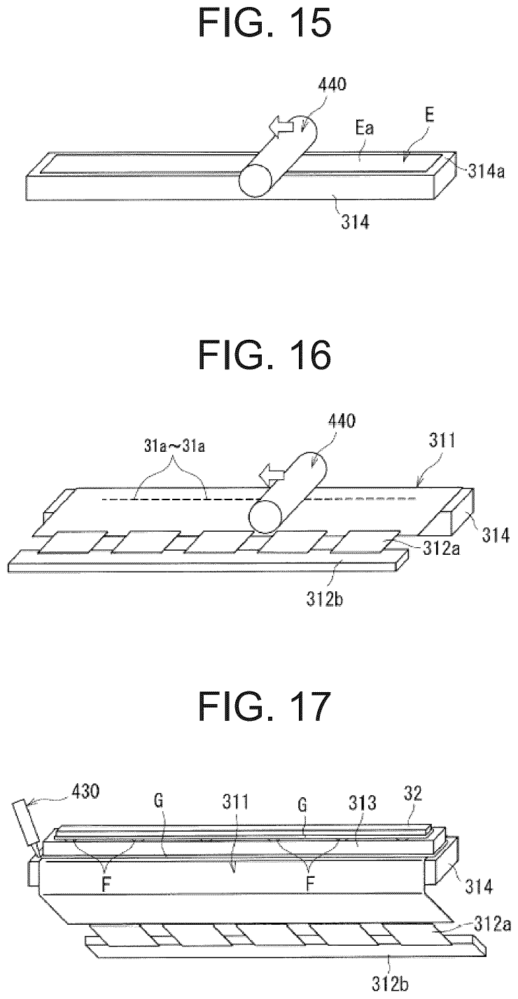

Next, as shown in FIG. 15, a pressure roller bonding device 440 is used to attach a piece of double-sided adhesive tape (E) (double-sided adhesive sheet) to a surface (314a) of the fixing member 314 where the light-emitting element panel 311 is to be attached, without removing a protective liner Ea on one side of the tape (fourth step).

Next, as shown in FIG. 16, the protective liner Ea on the one side of the double-sided adhesive tape (E) is removed, and the light-emitting element panel 311 is attached to the fixing member 314 using the pressure roller bonding device 440 with the plurality of light-emitting elements 31 in the light-emitting element panel 311 positioned at the reference positions on the fixing member 314 (fifth step).

Next, as shown in FIG. 17, the lens holder 313 holding the lens array 32 prepared in the third step (see FIG. 14) is placed on the light-emitting element panel 311 attached to the fixing member 314, and the sealant application device 430 is used to apply the sealant G (sealing resin) to a peripheral area between the lens holder 313 and the light-emitting element panel 311 to seal the gap between the lens holder 313 and the light-emitting element panel 311 (sixth step). Thus, dust and other foreign matter can be prevented from entering the lens holder 313 through the gap between the lens holder 313 and the light-emitting element panel 311.

### Regarding Embodiment of Present Disclosure

As shown in FIGS. 9 to 11, a print head 3 according to the embodiment of the present disclosure includes a substrate (311) (see FIGS. 9 and 10) having a plurality of light-emitting elements 31 arranged in a line, a lens array 32 that focuses light emitted by the plurality of light-emitting elements 31 onto a photoreceptor drum 1 (an example of an image carrier) (see FIG. 1), and a lens holder 313 that holds the lens array 32.

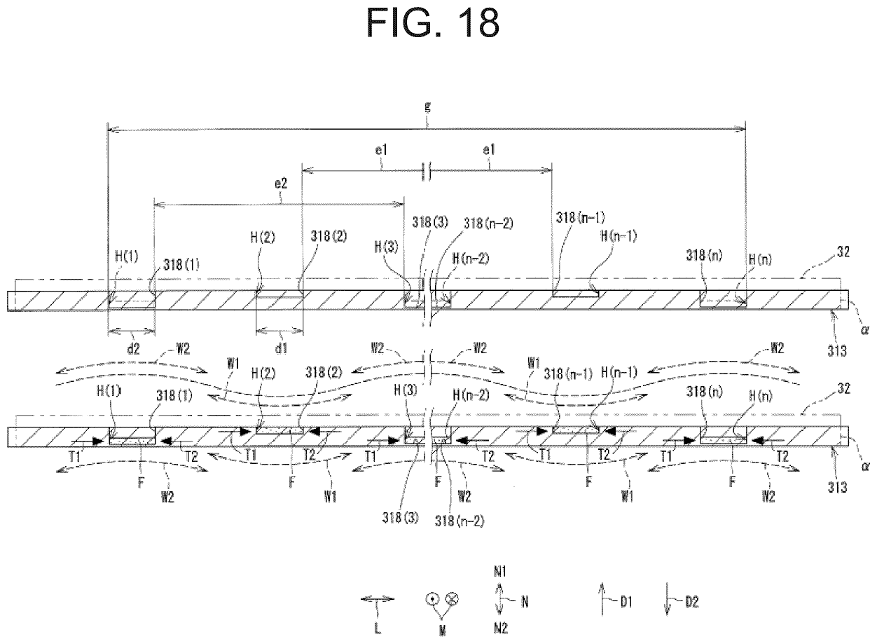

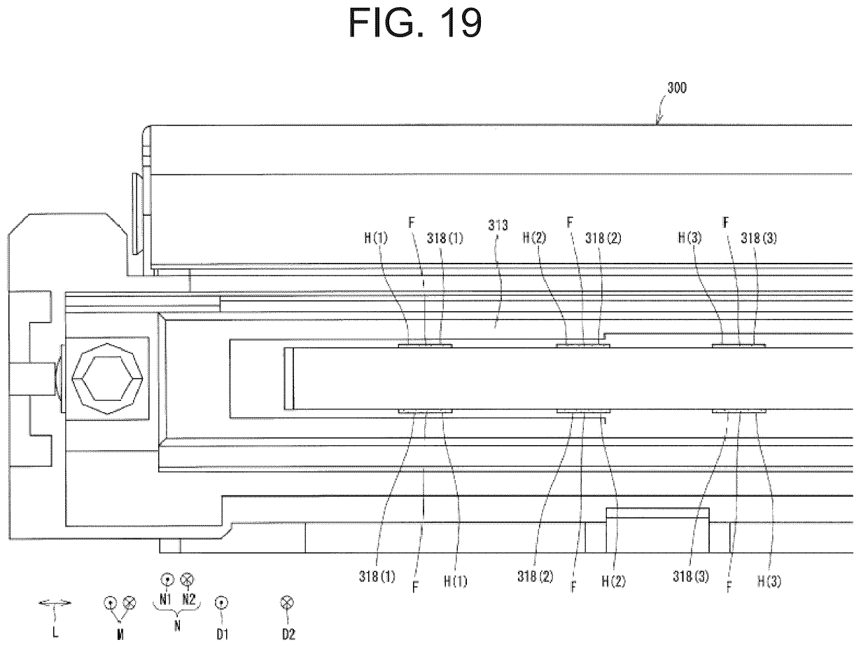

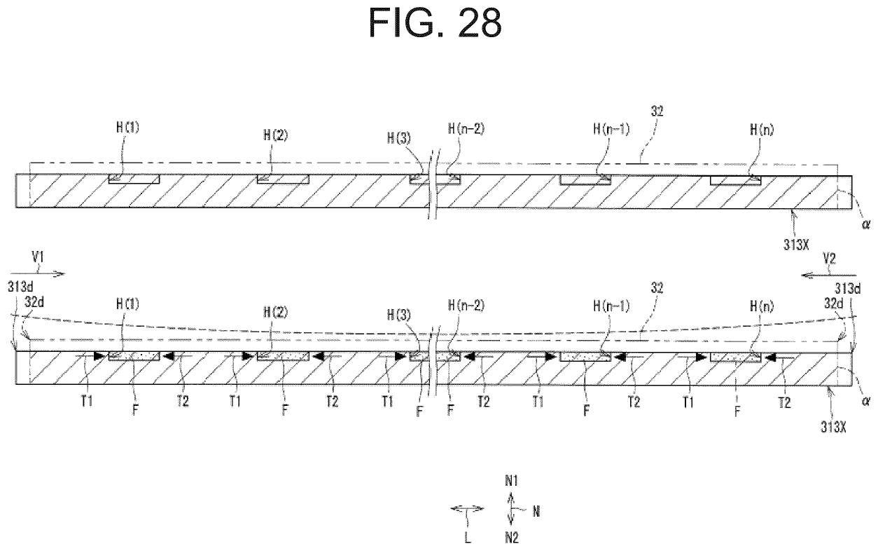

FIG. 28 is a diagram including vertical cross-sectional views of a reference example taken along the longitudinal direction L, illustrating an example of a portion of a lens holder 313X holding the lens array 32 before an adhesive (ultraviolet curing adhesive F in this example) is applied (upper illustration) and the portion of the lens holder 313X after the adhesive (F) has been applied (lower illustration). FIG. 18 is a diagram including vertical cross-sectional views of the embodiment of the present disclosure taken along the longitudinal direction L, illustrating an example of a portion of the lens holder 313 holding the lens array 32 before an adhesive (ultraviolet curing adhesive F in this example) is applied (upper illustration) and the portion of the lens holder 313 after the adhesive (F) has been applied (lower illustration). FIG. 19 is an enlarged plan view of a portion of the print head 3 including the lens holder 313 shown in FIG. 18.

In some cases, as shown in FIG. 28, FIG. 18, and FIG. 19, the lens array 32 and the lens holder 313 or 313X are bonded to each other using the adhesive (F) in a plurality of bonding regions H(1) to H(n) (n is an integer of two or more) arranged in the longitudinal direction L within a facing area α where the lens array 32 and the lens holder 313 or 313X face each other (region where the lens holder 313 or 313X holds the lens array 32). In regions within the facing area α other than the bonding regions H(1) to H(n), the lens array 32 and the lens holder 313 or 313X are in direct contact (close contact) with each other, and the adhesive (F) is not applied.

As shown in FIG. 28, in the case of the lens array 32 of the reference example, the plurality of bonding regions H(1) to H(n) are located only on the one side N1 in the optical axis direction N of the plurality of light-emitting elements 31 (photoreceptor drum 1 side in the example shown in FIG. 28) (concentrated toward one end in the optical axis direction N in the example shown in FIG. 28). In such a case, the following issues may arise.

That is, the adhesive (F) shrinks as the adhesive (F) cures. Consequently, each of the bonding regions H(1) to H(n) is subjected to forces toward the center thereof in the longitudinal direction L (in directions indicated by arrows T1 and T2) due to the shrinkage of the adhesive (F), and portions around two ends 313d of the lens holder 313 in the longitudinal direction L on a bonding regions H(1) to H(n) side in the optical axis direction N move inward (in directions indicated by arrows V1 and V2). This may eventually cause the lens holder 313X to warp (curve) into a bow shape (see a dashed line in FIG. 28).

The lens holder 313X is generally more rigid than the lens array 32. The lens array 32 bonded to the lens holder 313X therefore follows the lens holder 313X that has warped into a bow shape, and portions around two ends 32d of the lens array 32 in the longitudinal direction L on a bonding regions H(1) to H(n) side in the optical axis direction N move inward (in the directions indicated by arrows V1 and V2). This may eventually cause the lens array 32 to warp (curve) into a bow shape (see the dashed line in FIG. 28).

If warping occurs in the lens array 32 as described above, the distance between the lens array 32 and each individual light-emitting element 31 becomes inconsistent across different image heights, resulting in focus misalignment at positions offset from the reference plane of the lens array 32.

In this regard, in the embodiment of the present disclosure, the plurality of bonding regions H(1) to H(n) include first bonding regions H(2), . . . , H(n-1 or n) located on the one side N1 in the optical axis direction N (photoreceptor drum 1 side in this example) and second bonding regions H(1), H(3), . . . , H(n-2), H(n or n-1) located on an opposite side N2 in the optical axis direction N (substrate (311) side in this example). Note here that H(n-1) is the first bonding region at the terminal end and H(n) is the second bonding region at the terminal end, where n is an odd number. H(n) is the first bonding region at the terminal end and H(n-1) is the second bonding region at the terminal end, where n is an even number. In the example shown in FIG. 18, n is an odd number.

According to the embodiment of the present disclosure, in the facing area α, the first bonding regions H(2), . . . , H(n-1) are located on the one side N1 in the optical axis direction N, and the second bonding regions H(1), H(3), . . . , H(n) are located on the opposite side N2 in the optical axis direction N. Consequently, even if the adhesive (F) shrinks as the adhesive (F) cures and each of the bonding regions H(1) to H(n) is subjected to forces toward the center thereof in the longitudinal direction L (in directions indicated by arrows T1 and T2) due to the shrinkage of the adhesive (F), the forces toward the center in the longitudinal direction L exerted on the first bonding regions H(2), . . . , H(n-1) and the forces toward the center in the longitudinal direction L exerted on the second bonding regions H(1), H(3), . . . , H(n) can cancel each other out. Thus, it is possible to keep the lens holder 313 from warping into a bow shape and, in turn, the lens array 32 from warping into a bow shape.

Note here that a length of the adhesive (F) in the optical axis direction N after curing in the first bonding regions H(2), . . . , H(n-1) and the second bonding regions H(1), H(3), . . . , H(n) is approximately 1 mm or less. Specifically, the length in the optical axis direction N is approximately 0.3 mm to 0.5 mm. Similarly, a length of the adhesive (F) in a lateral direction (width direction M) is approximately 1 mm or less. Specifically, the length in the lateral direction is approximately 0.3 mm to 0.5 mm.

### Fifth Embodiment

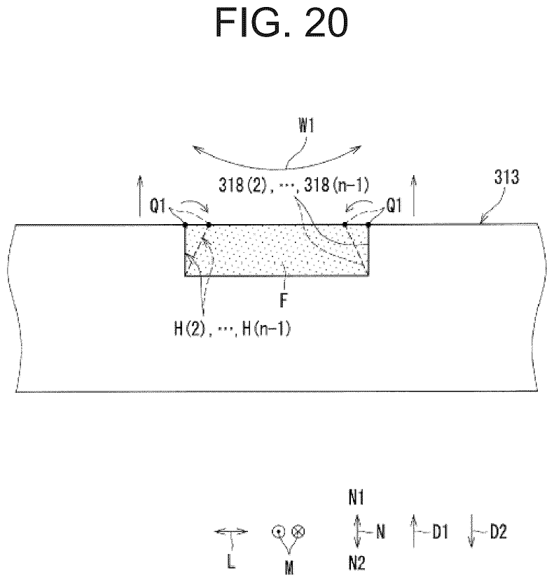

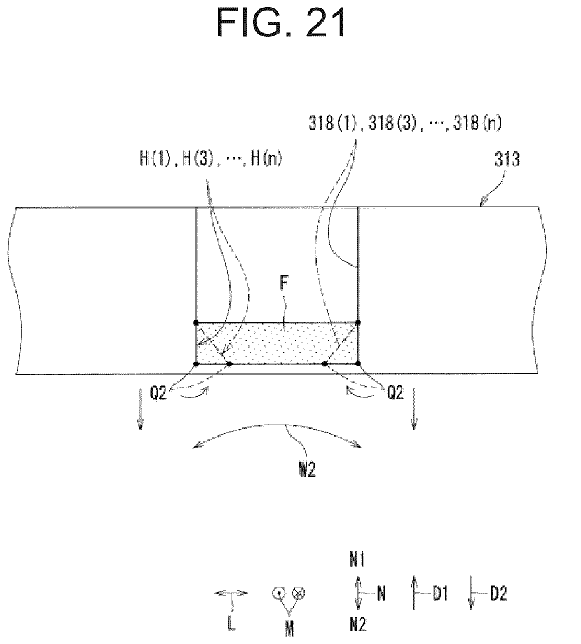

FIG. 20 is an explanatory diagram for explaining warping in a first warping direction W1 in each of the first bonding regions H(2), . . . , H(n-1). FIG. 21 is an explanatory diagram for explaining warping in a second warping direction W2 in each of the second bonding regions H(1), H(3), . . . , H(n).

As shown in FIG. 20, first edges Q1 of each of the first bonding regions H(2), . . . , H(n-1) at two ends thereof in the longitudinal direction L and at ends on the one side N1 in the optical axis direction N tend to move toward the center in the longitudinal direction L, and portions of the lens holder 313 corresponding to the respective first bonding regions H(2), . . . , H(n-1) tend to warp in the first warping direction W1 to be convex at the opposite side N2 in the optical axis direction N. By contrast, as shown in FIG. 21, second edges Q2 of each of the second bonding regions H(1), H(3), . . . , H(n) at two ends thereof in the longitudinal direction L and at ends on the opposite side N2 in the optical axis direction N tend to move toward the center in the longitudinal direction L, and portions of the lens holder 313 corresponding to the respective second bonding regions H(1), H(3), . . . , H(n) tend to warp in a second warping direction W2 to be convex at the one side N1 in the optical axis direction N.

In this regard, in the first embodiment, the first bonding regions H(2), . . . , H(n-1) and the second bonding regions H(1), H(3), . . . , H(n) are alternately arranged in the longitudinal direction L.

Since the first bonding regions H(2), . . . , H(n-1) and the second bonding regions H(1), H(3), . . . , H(n) are alternately arranged in the longitudinal direction L, this configuration allows the warping directions (the first warping direction W1 and the second warping direction W2) to alternate between the first bonding regions H(2), . . . , H(n-1) and the second bonding regions H(1), H(3), . . . , H(n) as shown in FIGS. 18 to 21. Thus, the forces toward the center in the longitudinal direction L exerted on each of the first bonding regions H(2), . . . , H(n-1) and the forces toward the center in the longitudinal direction L exerted on an adjacent one of the second bonding regions H(1), H(3), . . . , H(n) can cancel each other out. Thus, it is possible to keep the lens holder 313 from warping into a bow shape and, in turn, the lens array 32 from warping into a bow shape more effectively.

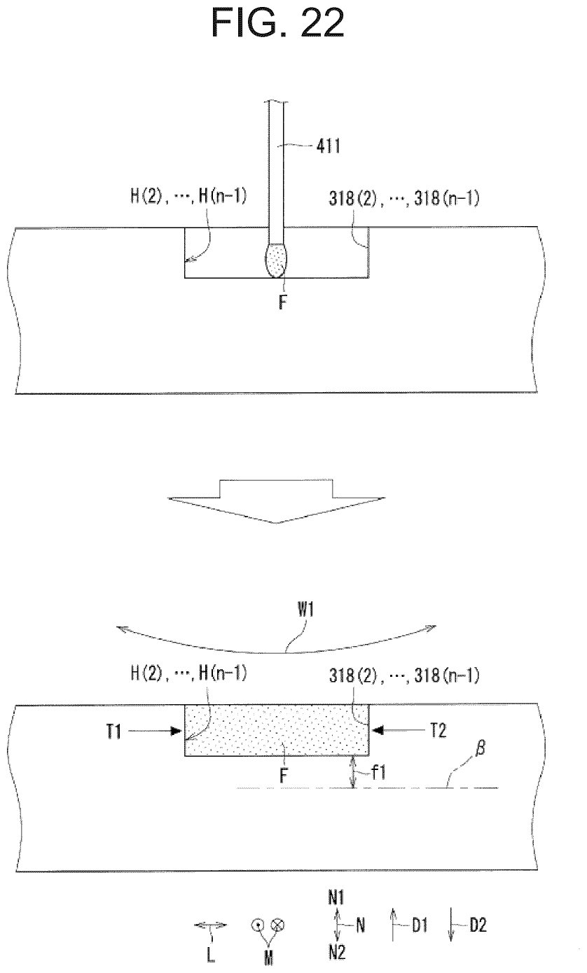

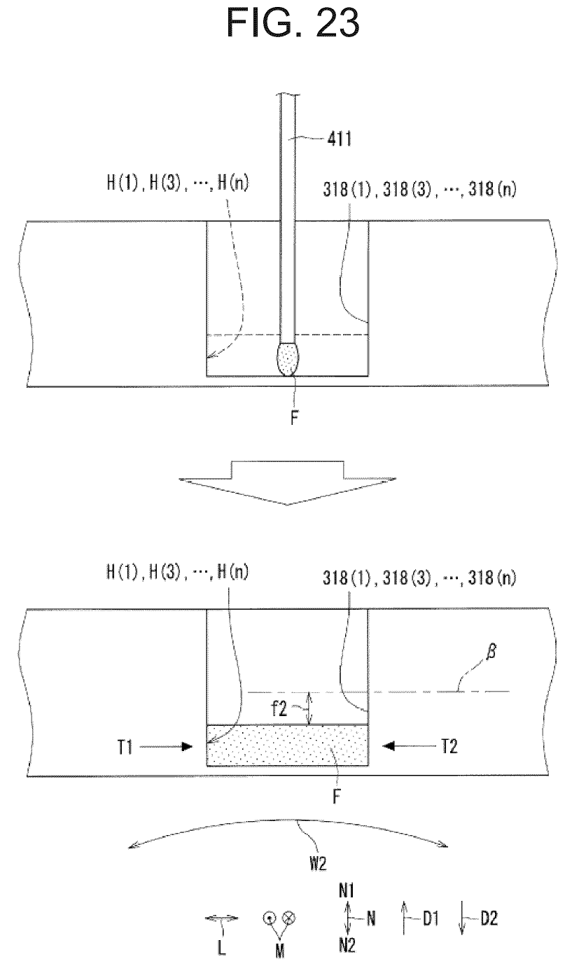

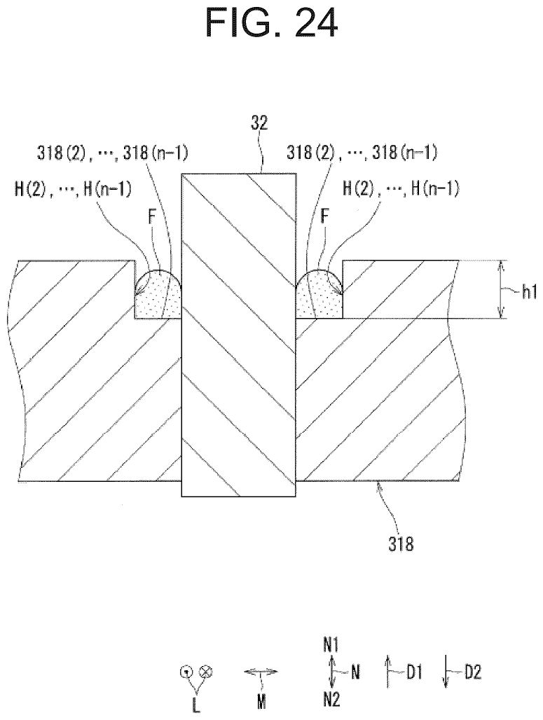

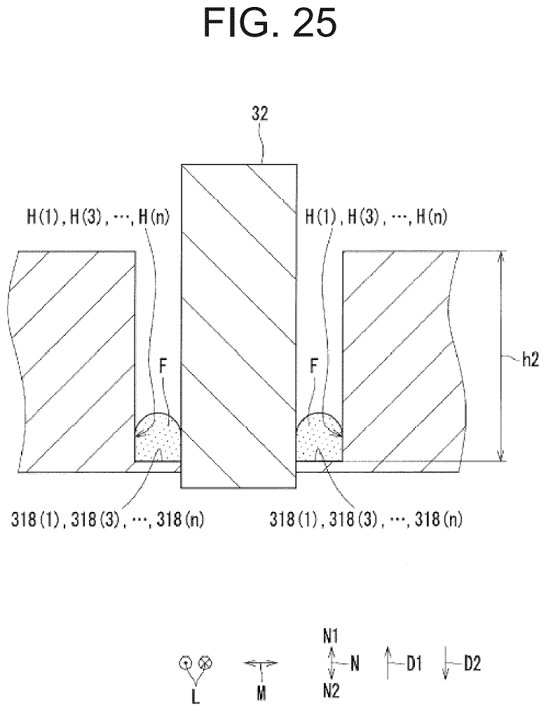

FIG. 22 is a diagram including vertical cross-sectional views taken along the longitudinal direction L, illustrating the lens holder 313 before the adhesive (F) is applied to the first bonding regions H(2), . . . , H(n-1) (upper illustration) and after the adhesive (F) has been applied (lower illustration). FIG. 23 is a diagram including vertical cross-sectional views taken along the longitudinal direction L, illustrating the lens holder 313 before the adhesive (F) is applied to the second bonding regions H(1), H(3), . . . , H(n) (upper illustration) and after the adhesive (F) has been applied (lower illustration). FIG. 24 is a vertical cross-sectional view taken along the width direction M, illustrating the lens holder 313 after the adhesive (F) has been applied to the first bonding regions H(2), . . . , H(n-1). FIG. 25 is a vertical cross-sectional view taken along the width direction M, illustrating the lens holder 313 after the adhesive (F) has been applied to the second bonding regions H(1), H(3), . . . , H(n).

In the first embodiment, at least one of the lens holder 313 or the lens array 32 (lens holder 313 in this example) has a plurality of recesses 318(1) to 318(n) for application of the adhesive (F).

The plurality of recesses 318(1) to 318(n) include first recesses 318(2), . . . , 318(n-1) for application of the adhesive (F) to the first bonding regions H(2), . . . , H(n-1) and second recesses 318(1), 318(3), . . . , 318(n) for application of the adhesive (F) to the second bonding regions H(1), H(3), . . . , H(n).

The first recesses 318(2), . . . , 318(n-1) and the second recesses 318(1), 318(3), . . . , 318(n) are all recessed in the same depth direction (a first depth direction D1 on the one side N1 or a second depth direction D2 on the opposite side N2 in the optical axis direction N; the second depth direction D2 in this example).

A second depth h2 (see FIG. 25) of the second recesses 318(1), 318(3), . . . , 318(n) is greater than a first depth h1 (see FIG. 24) of the first recesses 318(2), . . . , 318(n-1).

In this configuration, in order to apply the uncured adhesive (F) to the first bonding regions H(2), . . . , H(n-1) corresponding to the first recesses 318(2), . . . , 318(n-1) and the second bonding regions H(1), H(3), . . . , H(n) corresponding to the second recesses 318(1), 318(3), . . . , 318(n), a nozzle 411 of the dispenser 410 is first inserted into the first recesses 318(2), . . . , 318(n-1) and the second recesses 318(1), 318(3), . . . , 318(n) until the nozzle 411 reaches the first bonding regions H(2), . . . , H(n-1) and the second bonding regions H(1), H(3), . . . , H(n) as shown in FIGS. 22 and 23. Next, a constant amount of the adhesive (F) that does not exceed the extent of the first bonding regions H(2), . . . , H(n-1) and the second bonding regions H(1), H(3), . . . , H(n) is applied to the first bonding regions H(2), . . . , H(n-1) and the second bonding regions H(1), H(3), . . . , H(n).

This configuration makes it possible to apply the uncured adhesive (F) to the first bonding regions H(2), . . . , H(n-1) and the second bonding regions H(1), H(3), . . . , H(n) in the same depth direction (second depth direction D2 in this example), simplifying the step for application of the adhesive (F). Furthermore, since the second depth h2 is greater than the first depth h1, this configuration makes it possible to easily locate the first bonding regions H(2), . . . , H(n-1) on the one side N1 in the optical axis direction N and the second bonding regions H(1), H(3), . . . , H(n) on the opposite side N2 in the optical axis direction N within the facing area α.

Note here that the shape of the first recesses 318(2), . . . , 318(n-1) and the second recesses 318(1), 318(3), . . . , 318(n) is not particularly limited as long as the adhesive (F) can be applied to the bonding regions, and may have a rectangular bottom as in the first embodiment or an arc-shaped bottom, for example. This is also true for first recesses 318(2), . . . , 318(n-1) and second recesses 318(1), 318(3), . . . , 318(n) of a third embodiment described below.

### Second Embodiment

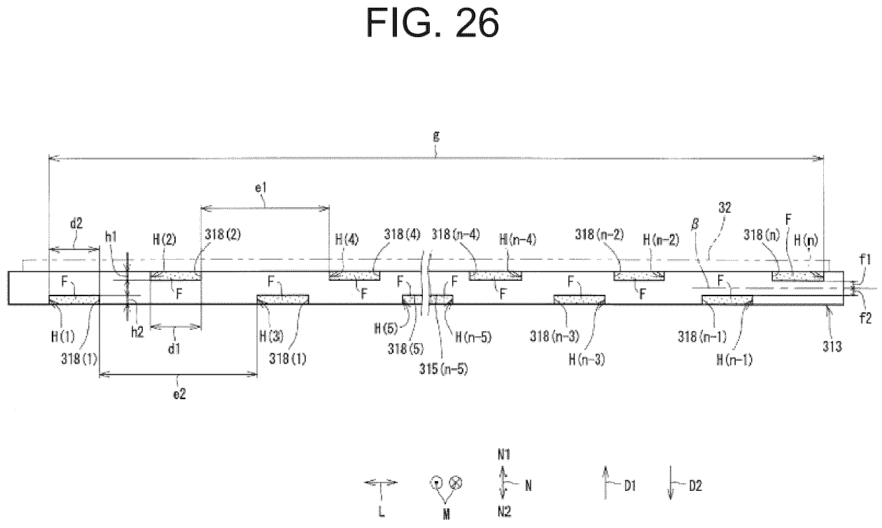

FIG. 26 is a vertical cross-sectional view of a second embodiment taken along the longitudinal direction L, illustrating another example of the portion of the lens holder 313 after the adhesive (F) has been applied.

In the second embodiment, the plurality of bonding regions H(1) to H(n) include first bonding regions H(2), . . . , H(n or n-1) located on the one side N1 in the optical axis direction N and second bonding regions H(1), H(3), . . . , H(n-2), H(n-1 or n) located on the opposite side N2 in the optical axis direction N. Note here that H(n) is the first bonding region at the terminal end and H(n-1) is the second bonding region at the terminal end, where n is an even number. H(n-1) is the first bonding region at the terminal end and H(n) is the second bonding region at the terminal end, where n is an odd number. In the example shown in FIG. 26, n is an even number.

According to the second embodiment, in the facing area α, the first bonding regions H(2), . . . , H(n-1) are located on the one side N1 in the optical axis direction N, and the second bonding regions H(1), H(3), . . . , H(n) are located on the opposite side N2 in the optical axis direction N. Consequently, even if the adhesive (F) shrinks as the adhesive (F) cures and each of the bonding regions H(1) to H(n) is subjected to forces toward the center thereof in the longitudinal direction L due to the shrinkage of the adhesive (F), the forces toward the center in the longitudinal direction L exerted on the first bonding regions H(2), . . . , H(n-1) and the forces toward the center in the longitudinal direction L exerted on the second bonding regions H(1), H(3), . . . , H(n) can cancel each other out. Thus, it is possible to keep the lens holder 313 from warping into a bow shape and, in turn, the lens array 32 from warping into a bow shape.

In the second embodiment, at least one of the lens holder 313 or the lens array 32 (lens holder 313 in this example) has a plurality of recesses 318(1) to 318(n) for application of the adhesive (F).

The plurality of recesses 318(1) to 318(n) include first recesses 318(2), . . . , 318(n-1) for application of the adhesive (F) to the first bonding regions H(2), . . . , H(n-1) and second recesses 318(1), 318(3), . . . , 318(n) for application of the adhesive (F) to the second bonding regions H(1), H(3), . . . , H(n).

The first recesses 318(2), . . . , 318(n-1) and the second recesses 318(1), 318(3), . . . , 318(n) are recessed in different depth directions. In this example, the first recesses 318(2), . . . , 318(n-1) are recessed in the second depth direction D2, having a depth toward the opposite side N2 in the optical axis direction N, and the second recesses 318(1), 318(3), . . . , 318(n) are recessed in the first depth direction D1, having a depth toward the one side N1 in the optical axis direction N.

In this configuration, the uncured adhesive (F) is applied to the first bonding regions H(2), . . . , H(n-1) in the second depth direction D2, and the uncured adhesive (F) is applied to the second bonding regions H(1), H(3), . . . , H(n) in a different direction, which is the first depth direction D1. Thus, this configuration allows the second depth h2 (see FIG. 26) for the second bonding regions H(1), H(3), . . . , H(n) to be shallower than the second depth h2 (see FIG. 25) for the second bonding regions H(1), H(3), . . . , H(n) according to the first embodiment, making it easier to perform the task of applying the uncured adhesive (F) to the second bonding regions H(1), H(3), . . . , H(n).

In the second embodiment, the second depth h2 of the second recesses 318(1), 318(3), . . . , 318(n) is the same as the first depth h1 (see FIG. 26) of the first recesses 318(2), . . . , 318(n-1).

Since the second depth h2 is the same as the first depth h1, this configuration makes it even easier to perform the task of applying the uncured adhesive (F) to the second bonding regions H(1), H(3), . . . , H(n).

### Third Embodiment

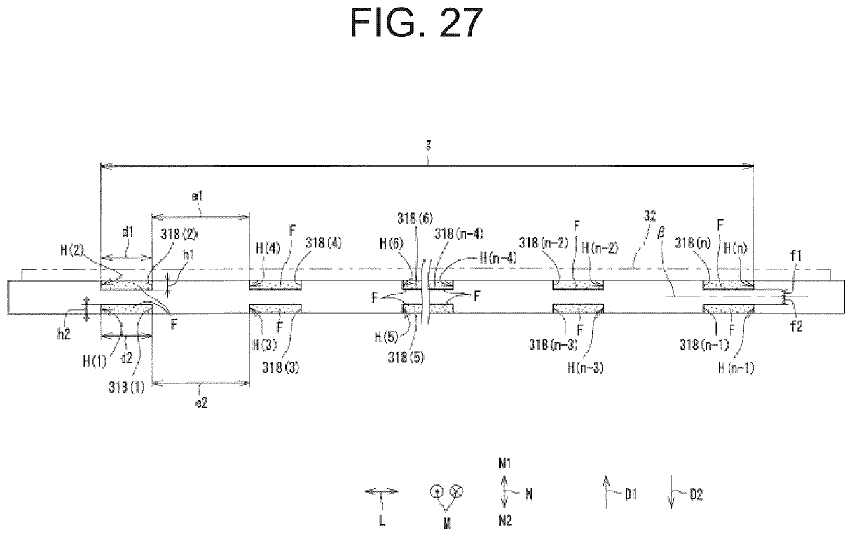

FIG. 27 is a vertical cross-sectional view of a third embodiment taken along the longitudinal direction L, illustrating another example of the portion of the lens holder 313 after the adhesive (F) has been applied.

In the third embodiment, the first bonding regions H(2), . . . , H(n-1) and the second bonding regions H(1), H(3), . . . , H(n) at least partially overlap in the longitudinal direction L (entirely in this example).

This configuration allows the cured adhesive (F) to firmly fix the lens array 32 and the lens holder 313 to each other at the locations where the first bonding regions H(2), . . . , H(n-1) and the second bonding regions H(1), H(3), . . . , H(n) overlap.

### Fourth Embodiment

In a fourth embodiment, first lengths d1 (see FIG. 18, FIG. 26, and FIG. 27) of the first bonding regions H(2), . . . , H(m) in the first to third embodiments (m1=n-1 in the example of the first embodiment, and m1=n in the examples of the second and third embodiments) in the longitudinal direction L are consistent. Second lengths d2 (see FIG. 18, FIG. 26, and FIG. 27) of the second bonding regions H(1), H(3), . . . , H(m2) (m2=n in the example of the first embodiment, and m1=n-1 in the examples of the second and third embodiments) in the longitudinal direction L are consistent. The first lengths d1 and the second lengths d2 are the same.

Since the first lengths d1 and the second lengths d2 are both consistent, this configuration makes it possible to arrange the first bonding regions H(2), . . . , H(m1) and the second bonding regions H(1), H(3), . . . , H(m2) in a well-balanced manner in the longitudinal direction L, and to keep the lens array 32 from warping into a bow shape more effectively.

### Fifth Embodiment

In a fifth embodiment, the numbers of the first bonding regions H(2), . . . , H(m1) and the second bonding regions H(1), H(3), . . . , H(m2) in the first to fourth embodiments are the same.

Since the number of the first bonding regions H(2), . . . , H(m1) is the same as the number of the second bonding regions H(1), H(3), . . . , H(m2), this configuration makes it possible to arrange the first bonding regions H(2), . . . , H(m1) and the second bonding regions H(1), H(3), . . . , H(m2) in a well-balanced manner in the longitudinal direction L, and to keep the lens array 32 from warping into a bow shape more effectively.

### Sixth Embodiment

In a sixth embodiment, the first bonding regions H(2), . . . , H(m1) in the first to fifth embodiments have consistent first distances e1 (see FIG. 18, FIG. 26, and FIG. 27) between adjacent first bonding regions [H(2) and H(4)], . . . , [H(m1-2) and H(m1)].

Since the first distances e1 are consistent, this configuration makes it possible to arrange the first bonding regions H(2), . . . , H(m1) in a well-balanced manner in the longitudinal direction L, and to keep the lens array 32 from warping into a bow shape more effectively.

### Seventh Embodiment

In a seventh embodiment, the second bonding regions H(1), H(3), . . . , H(m2) in the first to sixth embodiments have consistent second distances e2 (see FIG. 18, FIG. 26, and FIG. 27) between adjacent second bonding regions [H(1) and H(3)], . . . , [H(m2-2) and H(m2)].

Since the second distances e2 are consistent, this configuration makes it possible to arrange the second bonding regions H(1), H(3), . . . , H(m2) in a well-balanced manner in the longitudinal direction L, and to keep the lens array 32 from warping into a bow shape more effectively.

### Eighth Embodiment

In an eighth embodiment, the first distances e1 and the second distances e2 are the same.

Since the first distances e1 between adjacent first bonding regions [H(2) and H(4)], . . . , [H(m1-2) and H(m1)] are consistent, the second distances e2 between adjacent second bonding regions [H(1) and H(3)], . . . , [H(m2-2) and H(m2)] are consistent, and the first distances e1 and the second distances e2 are the same, this configuration makes it possible to arrange the first bonding regions H(2), . . . , H(m1) and the second bonding regions H(1), H(3), . . . , H(m2) in a well-balanced manner in the longitudinal direction L, and to keep the lens array 32 from warping into a bow shape even more effectively.

### Ninth Embodiment

In a ninth embodiment, distances f1 and f2 (see FIG. 22, FIG. 23, FIG. 26, and FIG. 27) from a virtual central line β, which is located at the center in the optical axis direction N and extends in the longitudinal direction L, to the first bonding regions H(2), . . . , H(m1) and the second bonding regions H(1), H(3), . . . , H(m2) in the first to eighth embodiments are the same.

This configuration makes it possible to arrange the first bonding regions H(2), . . . , H(m1) and the second bonding regions H(1), H(3), . . . , H(m2) in a more well-balanced manner in the optical axis direction N, and to keep the lens array 32 from warping into a bow shape even more effectively.

### Tenth Embodiment

In a tenth embodiment, a midpoint of a length g (see FIG. 18, FIG. 26, and FIG. 27) of the entire range of the bonding regions H(1) to H(mn) in the longitudinal direction L and a midpoint of the lens holder 313 and/or the lens array 32 in the longitudinal direction L in the first to ninth embodiments coincide.

This configuration makes it possible to keep the lens array 32 from warping equally on either side of the midpoint in the longitudinal direction L.

### Eleventh Embodiment

In an eleventh embodiment, the first bonding regions H(2), . . . , H(m1) and the second bonding regions H(1), H(3), . . . , H(m2) in the first to tenth embodiments, in which the lens array 32 and the lens holder 313 are bonded to each other, are provided on two sides in the lateral direction (width direction M) (see FIG. 19). In an example shown in FIG. 19, the first bonding regions H(2), . . . , H(m1) on the two sides overlap each other in the longitudinal direction L, and the second bonding regions H(1), H(3), . . . , H(m2) on the two sides overlap each other in the longitudinal direction L.

Since the lens array 32 and the lens holder 313 are bonded to each other in the first bonding regions H(2), . . . , H(m1) and the second bonding regions H(1), H(3), . . . , H(m2) provided on the two sides in the lateral direction (width direction M), this configuration makes it possible to arrange the first bonding regions H(2), . . . , H(m1) and the second bonding regions H(1), H(3), . . . , H(m2) in a more well-balanced manner in the lateral direction (M), and to keep the lens array 32 from warping into a bow shape even more effectively. This configuration also makes it possible to firmly fix the lens array 32 and the lens holder 313 to each other with the cured adhesive (F) in the first bonding regions H(2), . . . , H(m1) and the second bonding regions H(1), H(3), . . . , H(m2) provided on the two sides in the lateral direction (M).

Specific examples of forms of the first bonding regions H(2), . . . , H(m1) and the second bonding regions H(1), H(3), . . . , H(m2) provided on the two sides in the lateral direction (M) are as follows.
(a) The first bonding regions H(2), . . . , H(m1) provided on one side and the second bonding regions provided on the other side at least partially overlap in the longitudinal direction L. In this case, preferably, the centers of the first bonding regions H(2), . . . , H(m1) and the centers of the second bonding regions H(1), H(3), . . . , H(m2) in the longitudinal direction L coincide.
(b) The first bonding regions H(2), . . . , H(m1) provided on the one side and the first bonding regions H(2), . . . , H(m1) provided on the other side at least partially overlap in the longitudinal direction L. In this case, preferably, the centers of the first bonding regions H(2), . . . , H(m1) provided on the one side and the centers of the first bonding regions H(2), . . . , H(m1) provided on the other side in the longitudinal direction L coincide.
(c) The second bonding regions H(1), H(3), . . . , H(m2) provided on the one side and the second bonding regions H(1), H(3), . . . , H(m2) provided on the other side at least partially overlap in the longitudinal direction L. In this case, preferably, the centers of the second bonding regions H(1), H(3), . . . , H(m2) provided on the one side and the centers of the second bonding regions H(1), H(3), . . . , H(m2) provided on the other side in the longitudinal direction L coincide.
(d) The first bonding regions H(2), . . . , H(m1) provided on the one side and the second bonding regions H(1), H(3), . . . , H(m2) provided on the other side do not overlap in the longitudinal direction L.
(e) The first bonding regions H(2), . . . , H(m1) provided on the one side and the first bonding regions H(2), . . . , H(m1) provided on the other side do not overlap in the longitudinal direction L.
(f) The second bonding regions H(1), H(3), . . . , H(m2) provided on the one side and the second bonding regions H(1), H(3), . . . , H(m2) provided on the other side do not overlap in the longitudinal direction L.

In the forms (d) to (f), preferably, the second bonding regions H(1), H(3), . . . , H(m2) are positioned at the centers of respective spaces between adjacent first bonding regions [H(2) and H(4)], . . . , [H(m1-2) and H(m1)] in the longitudinal direction L, and the first bonding regions H(2), . . . , H(m1) are positioned at the centers of respective spaces between adjacent second adhesive regions [H(1) and H(3)], . . . , [H(m2-2) and H(m2)] in the longitudinal direction L.

The present disclosure is not limited to the embodiments described above and may be embodied in other specific forms. Therefore, such embodiments are merely examples in all respects and should not be construed as limiting. The scope of the present disclosure is indicated by the claims, and is not limited to the foregoing description. All modifications and variations that come within the equivalent scope of the claims are within the scope of the present disclosure.

What is claimed is:

1. A print head comprising:
a substrate having a plurality of light-emitting elements arranged in a line;
an elongated lens array that focuses light emitted by the plurality of light-emitting elements onto an image carrier; and
an elongated lens holder that holds the lens array, wherein
the lens array and the lens holder are bonded to each other in a plurality of bonding regions arranged in a longitudinal direction within a facing area where the lens array and the lens holder face each other, and
the plurality of bonding regions include first bonding regions located on one side in an optical axis direction of the plurality of light-emitting elements and second bonding regions located on an opposite side in the optical axis direction.

2. The print head according to claim 1, wherein the first bonding regions and the second bonding regions are alternately arranged in the longitudinal direction.

3. The print head according to claim 1, wherein
at least one of the lens holder or the lens array has a plurality of recesses for application of an adhesive,
the plurality of recesses include first recesses for application of the adhesive to the first bonding regions and second recesses for application of the adhesive to the second bonding regions, the first recesses having a first depth, the second recesses having a second depth,
the first recesses and the second recesses are all recessed in the same depth direction, and
the second depth of the second recesses is greater than the first depth of the first recesses.

4. The print head according to claim 1, wherein
at least one of the lens holder or the lens array has a plurality of recesses for application of an adhesive,
the plurality of recesses include first recesses for application of the adhesive to the first bonding regions and second recesses for application of the adhesive to the second bonding regions, the first recesses having a first depth, the second recesses having a second depth, and
the first recesses and the second recesses are recessed in different depth directions.

5. The print head according to claim 4, wherein the second depth of the second recesses is the same as the first depth of the first recesses.

6. The print head according to claim 4, wherein the first bonding regions and the second bonding regions at least partially overlap in the longitudinal direction.

7. The print head according to claim 1, wherein
first lengths of the first bonding regions in the longitudinal direction are consistent,
second lengths of the second bonding regions in the longitudinal direction are consistent, and
the first lengths and the second lengths are the same.

8. The print head according to claim 1, wherein
the number of the first bonding regions is the same,
the number of the second bonding regions is the same, and
the number of the first bonding regions and the number of the second bonding regions are the same.

9. The print head according to claim 1, wherein the first bonding regions have consistent first distances between adjacent first bonding regions.

10. The print head according to claim 1, wherein the second bonding regions have consistent second distances between adjacent second bonding regions.

11. The print head according to claim 1, wherein
the first bonding regions have consistent first distances between adjacent first bonding regions, and the second bonding regions have consistent second distances between adjacent second bonding regions, and
the first distances and the second distances are the same.

12. The print head according to claim 1, wherein the first bonding regions and the second bonding regions, in which the lens array and the lens holder are bonded to each other, are provided on two sides in a lateral direction.

13. An image forming apparatus comprising the print head according to claim 1.
